(19) United States
(12) Patent Application Publication
(10) Pub. No.: US 2021/0237710 A1
(43) Pub. Date: Aug. 5, 2021

(54) METHOD AND A CONTROL DEVICE FOR FACILITATING VEHICLE OPERATION OF A VEHICLE

(71) Applicant: Scania CV AB, Södertälje (SE)

(72) Inventors: Henrik FELIXSON, Årsta (SE); Ove BERGMARK, Huddinge (SE); Markus SVENSSON, Södertälje (SE); Jimmy NICHOLS, Nykvarn (SE); Bengt HARALDSSON, Farsta (SE)

(21) Appl. No.: 17/270,079

(22) PCT Filed: Aug. 27, 2019
(86) PCT No.: PCT/SE2019/050786

§ 371 Date: Feb. 22, 2021

(30) Foreign Application Priority Data
Sep. 5, 2018 (SE) 1851050-3

(51) Int. Cl. B60W 10/30; B60W 40/02

(52) U.S. Cl. CPC B60W 10/30; B60W 40/02; B60W 2556/50; B60W 2710/30; B60W 2510/30

(57) ABSTRACT

A method performed by a control device (100) for facilitating vehicle operation of a vehicle (V). Prior to vehicle operation, equipping the vehicle with at least one bodywork (BW) adding certain characteristics to the vehicle operation. Defining at least one generic zone, including a geographical zone (Z1) and/or a time zone (Z2). For the at least one generic zone, defining operational policies adapted to the vehicle and the at least one bodywork with which the vehicle has been equipped to ensure that the at least one bodywork operates in accordance with the thus defined operational policies when the vehicle operates within the at least one generic zone. Also, a control device for facilitating vehicle operation of a vehicle is provided. The invention also relates to a vehicle. The invention also relates to a computer program and a computer readable medium for the method.

### CROSS-REFERENCE TO RELATED APPLICATIONS

The present application is a 35 U.S.C. §§ 371 national phase conversion of PCT/SE2019/050786, filed Aug. 27, 2019, the contents of which are incorporated herein by reference which claims priority of Swedish Patent Application No. 1851050-3, filed Sep. 5, 2018, the contents of which are incorporated by reference herein. The PCT International Application was published in the English language.

### TECHNICAL FIELD

The invention relates to a method performed by a control device for facilitating operation of a vehicle. The invention also relates to a control device for facilitating operation of the vehicle. The invention further relates to a vehicle. The invention additionally relates to a computer program and a computer readable medium.

### BACKGROUND ART

For vehicles such as trucks, there may be certain policies which may affect vehicle operation. Such policies may relate to vehicle emissions, noise, speed or the like. Such policies may apply to certain areas and/or certain times during the day.

Vehicles such as trucks may need to adapt their vehicle operation to such policies. However, there may be situations where such zones associated with such policies are not sufficient in order to facilitate vehicle operation.

Therefore there is a need for facilitating vehicle operation of a vehicle in connection to zone management.

### OBJECTS OF THE INVENTION

An object of the present invention is to provide a method performed by a control device for facilitating operation of a vehicle.

Another object of the present invention is to provide a control device for facilitating operation of a vehicle.

Another object of the present invention is to provide a vehicle comprising such a control device.

### SUMMARY OF THE INVENTION

These and other objects, apparent from the following description, are achieved by a method, a control device, a vehicle, a computer program and a computer readable medium.

An object of the invention is achieved by a method performed by a control device for facilitating operation of a vehicle. Prior to vehicle operation, the method comprises the step of equipping the vehicle with at least one bodywork adding certain characteristics to the vehicle operation. Prior to vehicle operation, the method further comprises the step of defining at least one generic comprising a geographical zone and/or a time zone; and for the at least one generic zone, defining operational policies adapted to the vehicle and the at least one bodywork with which the vehicle has been equipped, so as to ensure that the at least one bodywork operates in accordance with the defined operational policies when the vehicle operates within the at least one generic zone.

A user may easily and efficiently create zones and adapt policies according to particular demands for the bodywork with which the vehicle has been equipped. Thus, efficient vehicle operation in desired zones with the vehicle being equipped with one or more bodyworks is facilitated. The at least one bodywork may e.g. comprise a salt spreader and the policies may comprise activating the salt spreader with a certain amount of salt when the vehicle is within such a zone. Thus, the bodywork, e.g. salt spreader, of the vehicle will be automatically activated to operate according to the defined policies when the vehicle enters the defined generic zone. Thus, vehicle operation may be easily adapted to user demands.

According to an embodiment, the method comprises the steps of, during vehicle operation: determining whether the vehicle is within the at least one generic zone. If it is determined that the vehicle is within the at least one generic zone, controlling the vehicle operation in the at least one generic zone based on the defined policies adapted to the vehicle and the at least one bodywork with which the vehicle has been equipped. Vehicle operation for the at least one bodywork may thereby be efficiently controlled in accordance with the defined policies in the defined zone. Thus, the vehicle operation for the at least one bodywork may be automatically activated and controlled when the vehicle enters and is within a defined generic zone.

According to an embodiment of the method, the step of controlling the vehicle operation in the at least one generic zone is performed automatically.

According to an embodiment, prior to vehicle operation, the method comprises the step of configuring a function of the at least one bodywork according to the defined policies for the at least one generic zone. This facilitates the bodywork function according to the policies when the vehicle is within a defined zone.

According to an embodiment, during vehicle operation, the method comprises the step of activating the configured function of the at least one bodywork according to the thus defined policies for the at least one generic zone when it is determined that the vehicle is within the at least one generic zone, to initiate the vehicle operation control. The bodywork will efficiently function according to the policies when the vehicle is within a thus defined zone.

Specifically an object of the invention is achieved by a control device for facilitating operation of a vehicle. Prior to vehicle operation, in connection with equipping the vehicle with at least one bodywork adding certain characteristics to the vehicle operation, the control device is configured establish operational connection with the at least one bodywork. The control device is further configured to define at least one generic zone based on zone definition information. The at least one generic zone comprises a geographical zone and/or a time zone. For the at least one generic zone, the control zone defines operational policies adapted to the vehicle and the at least one bodywork with which the vehicle has been equipped based on operational policy definition information. This is to ensure that the at least one bodywork operates in accordance with the thus defined operational policies when the vehicle operates within the at least one generic zone.

According to an embodiment, during vehicle operation, the control device is configured to determine whether the vehicle is within the at least one generic zone; and, if it is determined that the vehicle is within the at least one generic zone, control the vehicle operation in the at least one generic zone based on the defined policies adapted to the vehicle and the at least one bodywork with which the vehicle has been equipped.

According to an embodiment, the control device is configured to perform the control of the vehicle operation in the at least one generic zone automatically.

According to an embodiment, prior to vehicle operation, the control device is configured to be provided with information about configuration of a function of the at least one bodywork according to the thus defined policies for the at least one generic zone.

According to an embodiment, during vehicle operation, the control device is configured to activate the thus configured function of the at least one bodywork according to the thus defined policies for the at least one generic zone, when it is determined that the vehicle is within the at least one generic zone, so as to initiate the vehicle operation control.

Specifically an object of the invention is achieved by a vehicle comprising a control device as described herein.

Specifically, an object of the invention is achieved by a computer program for facilitating vehicle operation of a vehicle. The computer program comprises program code which, when run on a control device or another computer connected to the control device, causes the control device to perform the steps set out herein.

Specifically, an object of the invention is achieved by a non-transitory computer readable medium comprising program code containing instructions which, when executed by a computer, cause the computer to carry out the method set out herein.

### BRIEF DESCRIPTION OF THE DRAWINGS

For a better understanding of the present disclosure reference is made to the following detailed description when read in conjunction with the accompanying drawings, wherein like reference characters refer to like parts throughout the several views, and in which:

FIG. 1 schematically illustrates a side view of a vehicle according to an embodiment of the present disclosure;

FIG. 2 schematically illustrates zone management for facilitating vehicle operation of a vehicle according to an embodiment of the present disclosure;

FIG. 3 schematically illustrates a block diagram of a system for facilitating vehicle operation of a vehicle according to an embodiment of the present disclosure;

FIG. 4 schematically illustrates a flowchart of a method for facilitating vehicle operation of a vehicle according to an embodiment of the present disclosure;

FIG. 5 schematically illustrates a flowchart of a method for facilitating vehicle operation of a vehicle according to an embodiment of the present disclosure; and

FIG. 6 schematically illustrates a computer programmed with program code which executes the code and is according to an embodiment of the present disclosure.

### DETAILED DESCRIPTION

Hereinafter the term “link” refers to a communication link which may be a physical connector, such as an optoelectronic communication wire, or a non-physical connector such as a wireless connection, for example a radio or microwave link.

Hereinafter the term “generic zone” in relation to “defining at least one generic zone” refers to a geographical zone and/or a time zone. The term “geographical zone” may refer to any geographical area in connection to which a vehicle may operate. The term “geographical zone” may refer to a road or road segment along which the vehicle is travelling during vehicle operation. The term “geographical zone” may refer to an area in which the vehicle is intended to operate. The term “geographical zone” may refer to a city. The term “time zone” may refer to the time during which certain operational policies are desired/required to be adapted to the and bodywork with which the vehicle is equipped. A geographical zone and a time zone may be combined. A generic zone may be defined by the user to mean any kind of zone related to certain operation for a vehicle equipped with one or more certain bodyworks. A generic zone may e.g. be a salt zone in which a bodywork in the shape of a salt spreader is intended to be used during vehicle operation. A generic zone may e.g. be a temperature zone in which a bodywork in the shape of a cooling arrangement for controlling the temperature of goods/cargo is intended to be used during vehicle operation. A generic zone may e.g. be a cargo zone in which a bodywork in the shape of a tipper arrangement for tipping and/or loading/unloading arrangement for loading/unloading of cargo is intended to be used during vehicle operation.

Hereinafter the term “operational policies” in relation to “defining operational policies adapted to the vehicle and the at least one bodywork with which the vehicle has been equipped” may be any operational policies that are desired/intended/suited for operation of the particular vehicle and operation of the bodywork with which the vehicle has been equipped for the defined generic zone. An operational policy may be defined by one or more attributes describing a wanted behavior in relation to vehicle operation in connection to a geographical zone and/or time zone. An operational policy may be defined by the user to mean any kind of operational policy related to certain operation for a vehicle equipped with one or more certain bodyworks. An operational policy may e.g. be related to one or more of: amount of salt, where to salt, when to salt etc., for the activation and function of a bodywork in the shape of a salt spreader during vehicle operation in a generic zone defined as a salt zone. An operational policy may e.g. be related to which temperature a bodywork in the shape of a cooling arrangement for controlling the temperature of goods/cargo should keep the goods/cargo during vehicle operation in a generic zone defined as a temperature zone. An operational policy may e.g. be one or more of: where, when and how a bodywork in the shape of a tipper arrangement for tipping and/or loading/unloading arrangement for loading/unloading should tip and/or load and/or unload during vehicle operation in a generic zone defined as a cargo handling zone.

Hereinafter the term “bodywork” in relation to “a vehicle having been equipped with at least one bodywork adding certain characteristics to the vehicle operation” refers to any unit, function or the like which is not part of the vehicle and which, when added to the vehicle, adds certain characteristics to the vehicle operation. A bodywork may for example be a crane added to a truck and the function of the crane, a loading/unloading arrangement added to a truck for loading/unloading of goods, a tipping arrangement added to a truck for tipping of goods, an arrangement for handling garbage on a garbage truck, an arrangement for salting or sanding on the road, a cooling arrangement for handling goods that needs to be kept at a certain temperature, etc.

Hereinafter the term “vehicle operation” refers to any operation of the vehicle which may be relevant for any defined generic zone for which operational policies have been defined. The term “vehicle operation” may refer to certain characteristics added by one or more bodyworks with which the vehicle has been equipped the certain characteristics depending on the one or more bodyworks. The term “vehicle operation” may comprise vehicle operation of the actual vehicle, i.e. not provided by the bodywork. The term “vehicle operation” may comprise vehicle operation of the bodywork, i.e. bodywork operation.

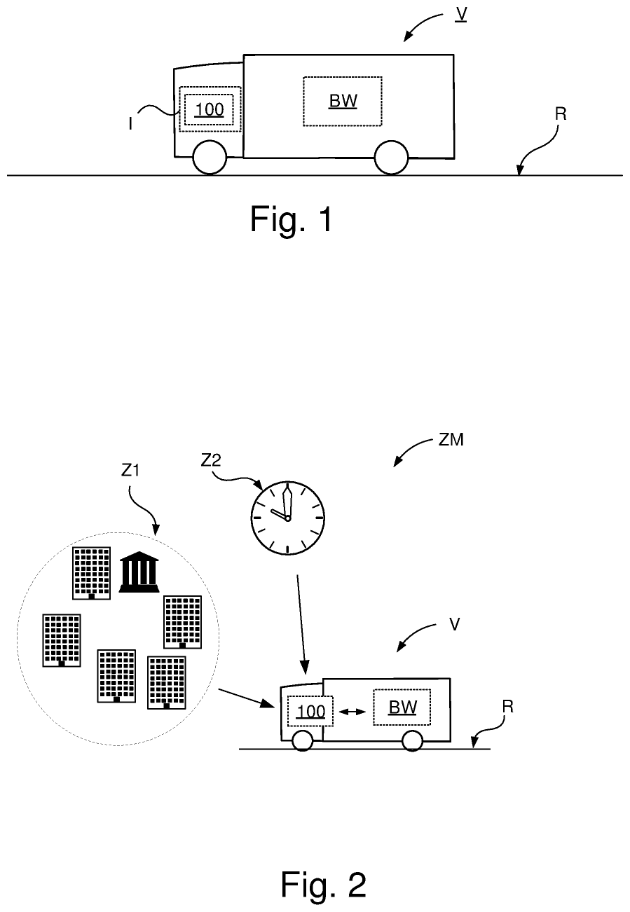

FIG. 1 schematically illustrates a side view of a vehicle V according to an embodiment of the present invention.

The exemplified vehicle V is a heavy vehicle in the shape of a truck. The vehicle V is travelling on a road R. The vehicle has been equipped with at least one bodywork BW adding certain characteristics to the vehicle operation.

The vehicle V may comprise a system I for facilitating vehicle operation of a vehicle. The system I may comprise a control device 100 for facilitating vehicle operation of a vehicle. The vehicle V may comprise a control device 100 for facilitating vehicle operation of a vehicle.

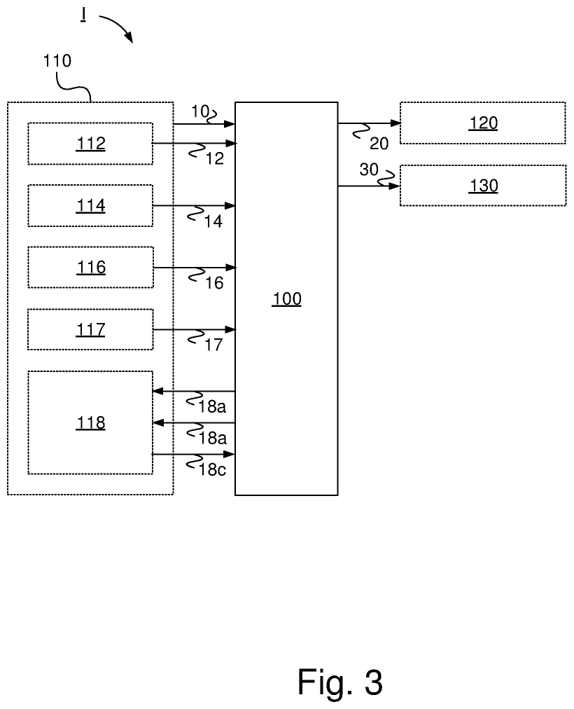

According to an embodiment, the vehicle V comprises, a system I for facilitating vehicle operation of a vehicle according to FIG. 3.

According to an embodiment, the vehicle V comprises a control device 100 for facilitating vehicle operation of a vehicle according to FIG. 3.

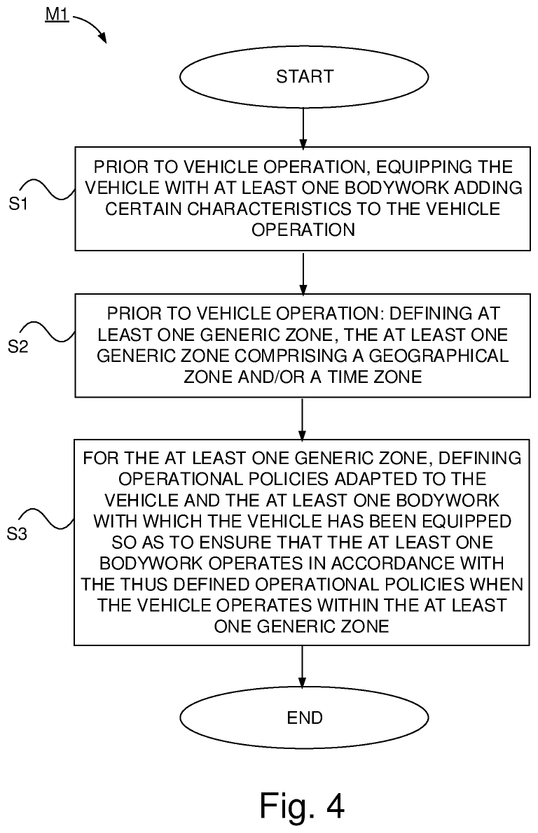

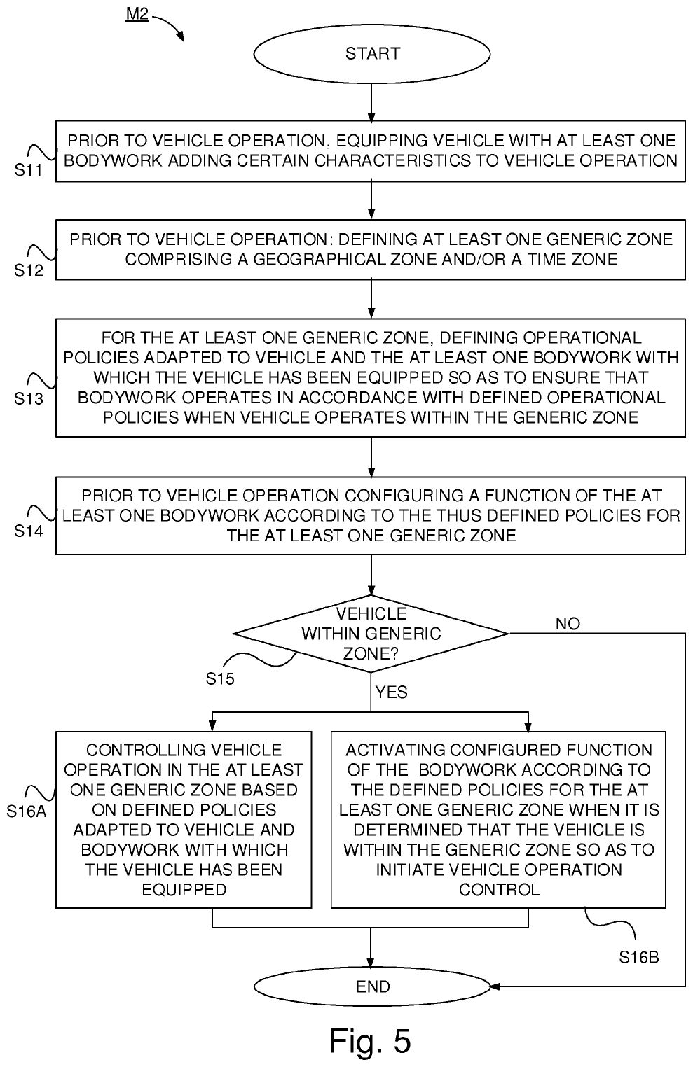

According to an embodiment, the vehicle V is arranged to be operated in accordance with a method M1, M2 for facilitating vehicle operation of a vehicle to FIG. 4 and/or FIG. 5.

According to the present invention, the vehicle may be any suitable vehicle having been equipped with at least one bodywork adding certain characteristics to the vehicle operation.

FIG. 2 schematically illustrates zone management ZM for facilitating vehicle operation of a vehicle V according to an embodiment of the present disclosure.

The vehicle V has been equipped with at least one bodywork BW adding certain characteristics to the vehicle operation. The vehicle is travelling on a road R. The vehicle comprises a control device 100 for facilitating vehicle operation of a vehicle. The control device 100 may be a control device 100 according to FIG. 3.

Defined generic zones Z1, Z2 are illustrated in FIG. 2. For the thus defined generic zones Z1, Z2 operational policies adapted to the vehicle and the at least one bodywork BW with which the vehicle has been equipped have been defined. The defined generic zones may have been defined by the user.

The defined generic zone may e.g. be a salt zone Z1, Z2. In this example a geographical zone Z1 in the form of an area, e.g. an area in a city, and a time zone Z2 are illustrated.

The geographical zone Z1 may for a salt zone be an area to be salted by means of the bodywork BW, i.e. salt spreader, of the vehicle. The time zone Z2 may for a salt zone be a certain time frame when the bodywork BW, i.e. salt spreader, of the vehicle shall spread salt in the geographical zone Z1. The road R or a segment/portion of the road R could also be a zone. The spreading of salt in the generic zones Z1, Z2 will then be automatically performed in accordance with the operational policies relating to e.g. degree of salt spreading. The spreading of salt may be automatically performed by means of the electronic control device 100 being operably connected to the bodywork, i.e. salt spreader.

FIG. 3 schematically illustrates a block diagram of a system I for facilitating vehicle operation of a vehicle according to an embodiment of the present invention.

The control device 100 for facilitating vehicle operation of a vehicle may be comprised in a system I for controlling vehicle communication during operation of a vehicle.

The control device 100 may be implemented as a separate entity or distributed in two or more physical entities. The control device 100 may comprise one or more computers. The control device 100 may thus be implemented or realized by the control device comprising a processor and a memory, wherein the memory comprising instructions, which when executed by the processor, causes the control device to perform the method herein disclosed.

The control device 100 may comprise one or more electronic control units, processing units, computers, server units or the like for facilitating vehicle operation of a vehicle. The control device 100 may comprise a control device such as one or more electronic control units arranged onboard a vehicle. The control device 100 may comprise one or more electronic control units of the vehicle. The control device 100 may comprise one or more electronic control units, processing units, computers, server units or the like of an off-board system arranged externally to the vehicle and being operably connectable to the vehicle.

The vehicle is equipped with at least one bodywork adding certain characteristics to the vehicle operation.

The control device 100 is configured to, prior to vehicle operation, in connection to equipping the vehicle with at least one bodywork adding certain characteristics to the vehicle operation, establish operational connection with the at least one bodywork.

Thus, connection and thereby communication between the vehicle and the at least one bodywork is arranged to be established. The connection and communication between the vehicle and the at least one bodywork may be arranged to be established within a vehicle-to-bodywork communication arrangement according to a variant to be operated by the operator of the vehicle.

Prior to vehicle operation, the control device 100 is further configured to, prior to vehicle operation, define at least one generic zone based on zone definition information. The at least one generic zone comprises a geographical zone and/or a time zone.

For the at least one generic zone, the control device 100 is further configured to define operational policies adapted to the vehicle and to the at least one bodywork, with which the vehicle has been equipped, based on operational policy definition information so as to ensure that the at least one bodywork operates in accordance with the thus defined operational policies when the vehicle operates within the at least one generic zone.

According to an embodiment, prior to vehicle operation, the control device 100 is configured to be provided with information about configuration of a function of the at least one bodywork according to the thus defined policies for the at least one generic zone.

According to an embodiment, the control device 100 is configured to determine whether the vehicle is within the at least one generic zone.

The system I may comprise a zone determination arrangement 110 arranged to determine whether the vehicle is within the at least one generic zone.

The control device 100 may comprise or be operably connectable to the zone determination arrangement 110.

The zone determination arrangement 110 may comprise a zone information receiving unit 112 arranged to receive information about a defined at least one generic zone.

The zone information receiving unit 112 may be arranged to receive information about the defined at least one generic zone from infrastructure via a vehicle-to-infrastructure communication arrangement.

The zone information receiving unit 112 may be arranged to receive information about the defined at least one generic zone from one or more other vehicles via a vehicle-to-vehicle communication arrangement.

The zone determination arrangement 110 may comprise a zone detection arrangement 114 arranged to detect the defined at least one generic zone. The zone detection arrangement 114 may comprise one or more sensors arranged to detect the defined at least one generic zone. The zone determination arrangement 110 may thus comprise one or more sensors arranged to detect the defined at least one generic zone. The zone detection arrangement 114, e.g. one or more sensors, may be arranged on board the vehicle and configured to detect the defined at least one generic zone.

The zone determination arrangement 110 may comprise a vehicle position identification device 116 for identifying the current position of the vehicle so as to determine whether the vehicle is within the at least one generic zone. The vehicle position identification device 116 may comprise a Global Navigation satellite System, GNSS, e.g. a global positioning system, GPS, arranged on board the vehicle.

The zone determination arrangement 110 may comprise a time determination device 117 for determining the current time. The time determination device 117 may be any suitable means for determining time. The time determination device 117 may comprise one or more clocks. The time determination device 117 may be comprised in the control device 100. The time determination device 117 may be comprised in the vehicle position identification device 116.

The zone determination arrangement 110 may comprise retrieving unit 118 arranged to retrieve stored information of the at least one generic zone. The retrieving unit 118 may be arranged to retrieve stored information of the defined operational policies for the at least one generic zone. The retrieving unit 118 may be arranged to retrieve such information from storage means. The storage means may be internal storage means arranged on board the vehicle and/or external storage means arranged externally to the vehicle. The storage means may comprise any suitable means for storing information/data about defined generic zones.

The zone determination arrangement 110 may be arranged to determine whether the vehicle is within the at least one generic zone taking current position of the vehicle and/or current time into consideration.

According to an embodiment the control device 100 is configured to control the vehicle operation in the at least one generic zone based on the thus defined policies adapted to the vehicle and the at least one bodywork with which the vehicle has been equipped.

The system I may comprise an operation control arrangement 120 arranged to control the vehicle operation in the at least one generic zone based on the thus defined policies adapted to the vehicle and the at least one bodywork with which the vehicle has been equipped.

The control device 100 may comprise or be operably connectable to the operation control arrangement 120.

According to an embodiment the control device 100 is configured to perform the control of the vehicle operation in the at least one generic zone automatically.

According to an embodiment the control device 100 is configured to, during vehicle operation, activate the thus configured function of the at least one bodywork according to the thus defined policies for the at least one generic zone when it is determined that the vehicle is within the at least one generic zone so as to initiate the vehicle operation control.

The system I may comprise bodywork activation arrangement 130 arranged to activate the thus configured function of the at least one bodywork according to the thus defined policies for the at least one generic zone.

The control device 100 may comprise or be operably connectable to the bodywork activation arrangement 130. The bodywork activation arrangement 130 may comprise, be comprised in or be operably connectable to the operation control arrangement 120.

According to an embodiment of the invention, the control device 100 is, via a link 10, operably connected to the zone determination arrangement 110. According to an embodiment of the invention, the control device 100 is via the link 10 arranged to receive a signal from the arrangement 110 representing data about whether the vehicle is within the at least one generic zone.

According to an embodiment of the invention, the control device 100 is, via a link 12, operably connected to the zone information receiving unit 112. According to an embodiment of the invention, the control device 100 is via the link 12 arranged to receive a signal from the zone information receiving unit 112 representing data comprising information about the at least one generic zone.

According to an embodiment of the invention, the control device 100 is, via a link 14, operably connected to the zone detection arrangement 114. According to an embodiment of the invention, the control device 100 is via the link 14 arranged to receive a signal from the zone detection arrangement 114 representing data about the defined at least one generic zone.

According to an embodiment of the invention, the control device 100 is, via a link 16, operably connected to the vehicle position identification device 116. According to an embodiment of the invention, the control device 100 is via the link 16 arranged to receive a signal from the vehicle position identification device 116 representing data about the position of the vehicle.

According to an embodiment of the invention, the control device 100 is, via a link 17, operably connected to the time determination device 117. According to an embodiment of the invention, the control device 100 is via the link 17 arranged to receive a signal from the time determination device 117 representing data about current time.

According to an embodiment of the invention, the control device 100 is, via a link 18a, operably connected to the retrieving unit 118. According to an embodiment of the invention, the control device 100 is via the link 18a arranged to send a signal to the retrieving unit 118 representing data about position of the vehicle.

According to an embodiment of the invention, the control device 100 is, via a link 18b, operably connected to the retrieving unit 118. According to an embodiment of the invention, the control device 100 is via the link 18b arranged to send a signal to the retrieving unit 118 representing data about current time.

The retrieving unit 118 may be arranged to process the data about position of the vehicle and/or data about current time so as to determine whether the vehicle is within the least one generic zone.

According to an embodiment of the invention, the control device 100 is, via a link 18c, operably connected to the retrieving unit 118. According to an embodiment of the invention, the control device 100 is via the link 18c arranged to receive a signal from the retrieving unit 118 representing data about one or more zones associated with certain communication policies relevant for vehicle communication.

According to an embodiment of the invention, the control device 100 is, via a link 20, operably connected to the operation control arrangement 120. According to an embodiment of the invention, the control device 100 is via the link 20 arranged to send a signal to the operation control arrangement 120 representing data about the vehicle being in the at least one generic zone so that vehicle operation shall be controlled based on the operational policies adapted to the vehicle and the at least one bodywork with which the vehicle has been equipped for the at least one generic zone.

According to an embodiment of the invention, the control device 100 is, via a link 30, operably connected to the bodywork activation arrangement 130. According to an embodiment of the invention, the control device 100 is via the link 30 arranged to send a signal to the operation control arrangement 130 representing data about the vehicle being/entering the at least one generic zone so that the configured function of the at least one bodywork shall be activated according to the thus defined policies for the at least one generic zone when.

The control device 100 is according to an embodiment configured to control the vehicle operation in the at least one generic zone based on the thus defined policies adapted to the vehicle and the at least one bodywork with which the vehicle has been equipped.

The control device 100 is according to an embodiment configured to control the vehicle operation automatically.

The control device 100 is according to an embodiment configured to control the vehicle operation automatically in such a way that the vehicle operator may not interrupt the automatic control. The control device 100 is according to an embodiment configured to control the vehicle operation automatically in such a way that the automatic control may be overridden by the vehicle operator. The control device 100 is according to an embodiment configured to control the vehicle operation automatically in such a way that the automatic control may be forced or overridden depending on operational policy and/or type of bodywork, i.e. type of operation by means the at least one bodywork, and/or type of generic zone.

The control device 100 according to the present invention may comprise or be operably connected to one or more of the arrangements 110, 120, 130 of the system I. The control device 100 according to the present invention may be operably connected to one or more of the arrangements 110, 120, 130 of the system I via any suitable link/links. The control device 100 for facilitating vehicle operation of a vehicle according to the present invention may comprise or be operably connected to other means/arrangement/units/devices.

The control device 100 for facilitating vehicle operation of a vehicle is, according to an embodiment, adapted to perform the method M1 described below with reference to FIG. 4 and/or the method M2 described below with reference to FIG. 5.

The system I for facilitating vehicle operation of a vehicle is, according to an embodiment, adapted to perform the method M1 described below with reference to FIG. 4 and/or the method M2 described below with reference to FIG. 5.

FIG. 4 schematically illustrates a flowchart of a method M1 performed by a control device for facilitating vehicle operation of a vehicle according to an embodiment of the present disclosure.

According to the embodiment, the method M1 for facilitating vehicle operation of a vehicle comprises a step S1. In this step, prior to vehicle operation, the vehicle is equipped with at least one bodywork adding certain characteristics to the vehicle operation. The step of equipping the vehicle with at least one bodywork adding certain characteristics to the vehicle operation comprises establishing operable connection with the control device. The control device is thus configured to establish operable connection with the at least one bodywork so as to control operation of the at least one bodywork during vehicle operation.

According to the embodiment, the method comprises a step S2. In this step, prior to vehicle operation, at least one generic zone is defined, the at least one generic zone comprising a geographical zone and/or a time zone. The control device is thereby configured to define at least one generic zone based on zone definition information prior to vehicle operation.

According to the embodiment, the method comprises a step S3. In this step, prior to vehicle operation, operational policies adapted to the vehicle and the at least one bodywork with which the vehicle has been equipped are defined for the at least one generic zone so as to ensure that the at least one bodywork operates in accordance with the thus defined operational policies when the vehicle operates within the at least one generic zone. The control device is thereby configured to define operational policies adapted to the vehicle and the at least one bodywork with which the vehicle has been equipped based on operational policy definition information.

The method M1 performed by a control device for facilitating vehicle operation of a vehicle is according to an embodiment adapted to be performed by the control device 100 described above with reference to FIG. 3.

The method M1 performed by a control device for facilitating vehicle operation of a vehicle is according to an embodiment adapted to be performed by the system I described above with reference to FIG. 3.

FIG. 5 schematically illustrates a flowchart of a method M2 performed by a control device for facilitating vehicle operation of a vehicle according to an embodiment of the present disclosure.

According to the embodiment, the method M2 for facilitating vehicle operation of a vehicle comprises a step S11. In this step, prior to vehicle operation, the vehicle is equipped with at least one bodywork adding certain characteristics to the vehicle operation. The step of equipping the vehicle with at least one bodywork adding certain characteristics to the vehicle operation comprises establishing operable connection with the control device. The control device is thus configured to establish operable connection with the at least one bodywork so as to control operation of the at least one bodywork during vehicle operation. Thus, connection and thereby communication between the vehicle and the at least one bodywork is established. The connection and communication between the vehicle and the at least one bodywork may be established within a vehicle-to-bodywork communication arrangement.

According to the embodiment, the method comprises a step S12. In this step, prior to vehicle operation, at least one generic zone is defined, the at least one generic zone comprising a geographical zone and/or a time zone. The control device is thereby configured to define at least one generic zone based on zone definition information prior to vehicle operation.

According to the embodiment, the method comprises a step S13. In this step, prior to vehicle operation, operational policies adapted to the vehicle and the at least one bodywork with which the vehicle has been equipped are defined for the at least one generic zone so as to ensure that the at least one bodywork operates in accordance with the thus defined operational policies when the vehicle operates within the at least one generic zone. The control device is thereby configured to define operational policies adapted to the vehicle and the at least one bodywork with which the vehicle has been equipped based on operational policy definition information.

According to the embodiment, the method comprises a step S14. In this step, prior to vehicle operation, a function of the at least one bodywork is configured according to the thus defined policies for the at least one generic zone.

According to the embodiment, the method comprises a step S15. In this step, during vehicle operation, it is determined whether the vehicle is within the at least one generic zone.

The step S15 of determining whether the vehicle is within the at least one generic zone may comprise the step of receiving information about at least one zone associated with certain policies relevant for the operation of the vehicle.

The step S15 of determining whether the vehicle is within the at least one generic zone may comprise the step of detecting the at least one zone associated with certain policies relevant for the operation of the vehicle. The step of detecting may comprise utilizing one or more sensors suitable for detecting such zones.

The step S15 of determining whether the vehicle is within the at least one generic zone may comprise the step of detecting and/or identifying the current position of the vehicle. Identification of the current position of the vehicle may be performed by means of a Global Navigation satellite System, GNSS, e.g. a global positioning system, GPS, arranged on board the vehicle.

The step S15 of determining whether the vehicle is within the at least one generic zone may comprise the step of determining the current time.

The step S15 of determining whether the vehicle is within the at least one generic zone may comprise the step of retrieving stored information of the at least one zone associated with certain policies relevant for the operation of the vehicle.

The step S15 of determining whether the vehicle is within the at least one generic zone may be performed taking current position of the vehicle and/or current time into consideration.

According to the embodiment, the method comprises a step S16A. In this step, if it is determined that the vehicle is within the at least one generic zone, the vehicle operation is controlled in the at least one generic zone based on the thus defined policies adapted to the vehicle and the at least one bodywork with which the vehicle has been equipped.

According to the embodiment, the method comprises a step S16A. In this step, during vehicle operation, the thus configured function of the at least one bodywork is activated according to the thus defined policies for the at least one generic zone when it is determined that the vehicle is within the at least one generic zone so as to initiate the vehicle operation control.

According to an embodiment of the method, the step of controlling the vehicle operation in the at least one generic zone is performed automatically.

The method M2 performed by a control device for facilitating vehicle operation of a vehicle is according to an embodiment adapted to be performed by the control device 100 described above with reference to FIG. 3.

The method M2 performed by a control device for facilitating vehicle operation of a vehicle is according to an embodiment adapted to be performed by the system I described above with reference to FIG. 3.

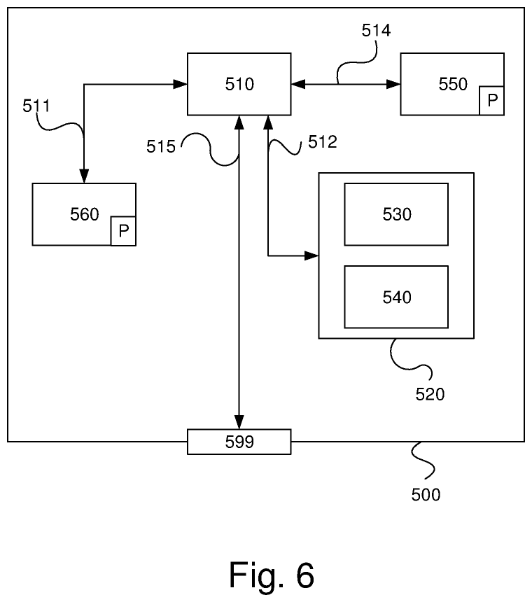

With reference to FIG. 6, a diagram of a computer 500/apparatus 500 is shown. The control device 100 described with reference to FIG. 3 may according to an embodiment comprise apparatus 500. Apparatus 500 comprises a non-volatile memory 520, a data processing device 510 and a read/write memory 550. Non-volatile memory 520 has a first memory portion 530 wherein a computer program, such as an operating system, is stored for controlling the function of apparatus 500. Further, apparatus 500 comprises a bus controller, a serial communication port, I/O-means, an A/D-converter, a time date entry and transmission unit, an event counter and an interrupt controller (not shown). Non-volatile memory 520 also has a second memory portion 540.

A computer program P is provided comprising routines for facilitating vehicle operation of a vehicle.

The program P comprises routines for determining at least one zone associated with certain communication policies relevant for the vehicle communication. The program P comprises routines for, prior to vehicle operation, operably connecting the vehicle with at least one bodywork adding certain characteristics to the vehicle operation. The program P comprises routines for, prior to vehicle operation: defining at least one generic zone, the at least one generic zone comprising a geographical zone and/or a time zone based on zone definition information. The program P comprises routines for defining operational policies adapted to the vehicle and the at least one bodywork with which the vehicle has been equipped for the at least one generic zone based on operational policy definition information so as to ensure that the at least one bodywork operates in accordance with the thus defined operational policies when the vehicle operates within the at least one generic zone.

The program P comprises routines for, prior to vehicle operation, configuring a function of the at least one bodywork according to the thus defined policies for the at least one generic zone.

The program P comprises routines for, during vehicle operation: determining whether the vehicle is within the at least one generic zone.

The program P comprises routines for controlling the vehicle operation in the at least one generic zone is performed automatically.

The program P comprises routines for controlling the vehicle operation in the at least one generic zone based on the thus defined policies adapted to the vehicle and the at least one bodywork with which the vehicle has been equipped if determined that the vehicle is within the at least one generic zone.

The program P comprises routines for activating the thus configured function of the at least one bodywork according to the thus defined policies for the at least one generic zone when it is determined that the vehicle is within the at least one generic zone so as to initiate the vehicle operation control.

The computer program P may be stored in an executable manner or in a compressed condition in a separate memory 560 and/or in read/write memory 550.

When it is stated that data processing device 510 performs a certain function, it should be understood that data processing device 510 performs a certain part of the program which is stored in separate memory 560, or a certain part of the program which is stored in read/write memory 550.

Data processing device 510 may communicate with a data communications port 599 by means of a data bus 515. Non-volatile memory 520 is adapted for communication with data processing device 510 via a data bus 512. Separate memory 560 is adapted for communication with data processing device 510 via a data bus 511. Read/write memory 550 is adapted for communication with data processing device 510 via a data bus 514. To the data communications port 599 e.g. the links connected to the control unit 100 may be connected.

When data is received on data port 599, it is temporarily stored in second memory portion 540. When the received input data has been temporarily stored, data processing device 510 is set up to perform execution of code in a manner described above. The signals received on data port 599 may be used by apparatus 500 for determining at least one zone associated with certain communication policies relevant for the vehicle communication. The signals received on data port 599 may be used by apparatus 500, prior to vehicle operation, for operable connecting the vehicle with at least one bodywork adding certain characteristics to the vehicle operation. The signals received on data port 599 may be used by apparatus 500, prior to vehicle for operation: defining at least one generic zone, the at least one generic zone comprising a geographical zone and/or a time zone based on zone definition information. The signals received on data port 599 may be used by apparatus 500 for defining operational policies adapted to the vehicle and the at least one bodywork with which the vehicle has been equipped for the at least one generic zone based on operational policy definition information so as to ensure that the at least one bodywork operates in accordance with the thus defined operational policies when the vehicle operates within the at least one generic zone.

The signals received on data port 599 may be used by apparatus 500, prior to vehicle operation, for configuring a function of the at least one bodywork according to the thus defined policies for the at least one generic zone.

The signals received on data port 599 may be used by apparatus 500, during vehicle operation: for determining whether the vehicle is within the at least one generic zone.

The signals received on data port 599 may be used by apparatus 500 for controlling the vehicle operation in the at least one generic zone to be performed automatically.

The signals received on data port 599 may be used by apparatus 500 for controlling the vehicle operation in the at least one generic zone based on the thus defined policies adapted to the vehicle and the at least one bodywork with which the vehicle has been equipped, if it is determined that the vehicle is within the at least one generic zone.

The signals received on data port 599 may be used by apparatus 500 for activating the thus configured function of the at least one bodywork according to the thus defined policies for the at least one generic zone when it is determined that the vehicle is within the at least one generic zone so as to initiate the vehicle operation control.

Parts of the methods described herein may be performed by apparatus 500 by means of data processing device 510 running the program stored in separate memory 560 or read/write memory 550. When apparatus 500 runs the program, parts of the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method (M1, M2) performed by a control device for facilitating vehicle operation of a vehicle (V), comprising the steps of, prior to vehicle operation:
equipping the vehicle with at least one bodywork (BW) for adding selected characteristics to the vehicle operation;
defining at least one generic zone comprising a geographical zone (Z1) and/or a time zone (Z2); and,
for the at least one generic zone, defining operational policies adapted to the vehicle (V) and to the at least one bodywork (BW) with which the vehicle has been equipped to ensure that the at least one bodywork (BW) operates in accordance with the thus defined operational policies when the vehicle (V) operates within the at least one generic zone.

2. The method according to claim 1, further comprising the steps of, during vehicle operation: determining whether the vehicle is within the at least one generic zone (Z1, Z2); and, if it is determined that the vehicle is within the at least one generic zone, controlling the vehicle operation in the at least one generic zone based on the thus defined policies adapted to the vehicle and the at least one bodywork with which the vehicle has been equipped.

3. The method according to claim 2, wherein step of controlling the vehicle operation in the at least one generic zone is performed automatically.

4. The method according to claim 1, comprising the step of, prior to vehicle operation, configuring a function of the at least one bodywork according to the thus defined policies for the at least one generic zone.

5. The method according to claim 4, comprising the step of, during vehicle operation, activating the thus configured function of the at least one bodywork according to the thus defined policies for the at least one generic zone when it is determined that the vehicle is within the at least one generic zone for initiating the vehicle operation control.

6. A control device for facilitating vehicle operation of a vehicle (V), the control device being configured to, prior to vehicle operation:
in connection with equipping the vehicle with at least one bodywork (BW) adding certain characteristics to the vehicle operation, establish operational connection with the at least one bodywork;
defining at least one generic zone based on zone definition information, the at least one generic zone comprising a geographical zone (Z1) and/or a time zone (Z2); and,
for the at least one generic zone, defining operational policies adapted to the vehicle (V) and to the at least one bodywork (BW) with which the vehicle has been equipped based on operational policy definition information so as to ensure that the at least one bodywork (BW) operates in accordance with the thus defined operational policies when the vehicle (V) operates within the at least one generic zone.

7. The control device according to claim 6, wherein the control device is configured, during vehicle operation: to determine whether the vehicle is within the at least one generic zone (Z1, Z2); and, if it is determined that the vehicle is within the at least one generic zone, controlling the vehicle operation in the at least one generic zone based on the thus defined policies adapted to the vehicle and the at least one bodywork with which the vehicle has been equipped.

8. The control device according to claim 7, wherein the control device is configured to perform the control of the vehicle operation in the at least one generic zone automatically.

9. The control device according to claim 7, wherein the control device is configured prior to vehicle operation, to configure a function of the at least one bodywork (BW) according to the thus defined policies for the at least one generic zone.

10. The control device according to claim 9, wherein the control device is during vehicle operation, to activate the thus configured function of the at least one bodywork (BW) according to the thus defined policies for the at least one generic zone when it is determined that the vehicle is within the at least one generic zone so as to initiate the vehicle operation control.

11. A vehicle comprising a control device according to claim 6.

12. A computer program (P) for facilitating vehicle operation of a vehicle, the computer program (P) comprising program code which, when run on a control device or on another computer connected to the control device, causes the control device to perform the steps according to claim 1.

13. A computer readable medium comprising instructions which, when executed by a computer, cause the computer to carry out the method according to claim 1.

14. A non-transitory recording medium for a computer program including a computer program (P) for facilitating vehicle operation of a vehicle, the computer program (P) comprising program code which, when run on a control device or another computer connected to the control device, causes the control device to perform the steps according to claim 1.
